(19) United States
(12) Patent Application Publication
(10) Pub. No.: US 2015/0348136 A1
(43) Pub. Date: Dec. 3, 2015

(54) Calculating Bids for Advertisements Based on Conversion Value

(71) Applicant: Facebook, Inc., Menlo Park, CA (US)

(72) Inventors: Jun Yang, Sunnyvale, CA (US); Richard Bill Sim, Belmont, CA (US); Eitan Shay, Palo Alto, CA (US)

(73) Assignee: Facebook, Inc., Menlo Park, CA (US)

(21) Appl. No.: 14/292,659

(22) Filed: May 30, 2014

(51) Int. Cl. G06Q 30/02

(52) U.S. Cl. CPC G06Q 30/0275

(57) ABSTRACT

An advertising platform calculates bids for advertisements based on the value of a conversion for the advertisement. The advertising platform identifies an impression opportunity for an advertisement request and computes an expected value of the conversion as well as a likelihood of the conversion. The advertising platform computes a bid amount based on the expected conversion value and the likelihood of the conversion. Bids based on the value of the conversion allow advertisers to optimize for the value of each conversion instead of simply the conversion rate.

### BACKGROUND

This invention relates generally to online advertising and more specifically to bidding on online advertisements.

Advertising platforms generate revenue using targeted advertising. Targeted advertising is more cost-effective than traditional forms of advertising because a targeted advertisement is only shown to a viewing user likely to be interested in the advertisement. Advertising platforms use an auction process to select an advertisement for each impression, i.e. an instance that an advertisement can be shown to the viewing user. The auction process selects an advertisement based on a bid associated with the advertisement. The value of the bids associated with the advertisement are based on the conversion rate, or the number of times the advertisement leads to a successful business objective, such as the viewing user clicking on a link or purchasing a product. However, bids based on conversion rates do not take into account the value of the conversion. Thus, advertisements with high conversion values that also have low conversion rates are often overlooked by conventional advertising platforms or are not as competitive in an ad auction process since bids associated with ads are optimized for the number of conversions.

### SUMMARY

An advertising platform allows advertisers to bid on advertisements by specifying a minimum return on investment (ROI), or an amount that the advertiser is willing to pay per unit of value of a conversion of the advertisement. The platform receives an advertisement request from an advertiser to present an advertisement to users of an online system. The platform also receives bidding input from the advertiser that is used to determine the minimum ROI or ratio representing the amount per unit value. When an impression opportunity to provide advertising to a viewing user of the online system arises, the advertising platform determines an expected value of a conversion of the advertisement for that impression opportunity. The platform computes a bid amount based on the determined expected value scaled by the minimum ROI. The determined expected value can be based on (1) a likelihood of a conversion of the advertisement by the viewing user and (2) an estimated value of a conversion of the advertisement by the viewing user. In one embodiment, the bid amount is computed as based on a product of the minimum ROI, the likelihood of a conversion for the advertisement, and the estimated value of the conversion for the advertisement. The computed bid amount for the ad can then be used in an advertisement selection process or ad auction in which ads are selected for presentation to the viewing user.

The likelihood of conversion of the advertisement may be based on any number of user and ad-specific features. The estimated value of a conversion of the advertisement may be specified by the advertiser or determined by the advertising platform, which may use user-specific information known by the advertising platform in addition to information about the advertised product or service known by the advertiser. This bidding system allows advertisers to optimize for the monetary value of conversions of an advertisement, rather than merely the number of conversions.

### BRIEF DESCRIPTION OF THE DRAWINGS

FIG. 1 is a block diagram of a system environment for an advertising platform, in accordance with an embodiment of the invention.

FIG. 2 is a block diagram of a social networking system, in accordance with an embodiment of the invention.

FIG. 3 is a flow diagram of the bid computing process within the system of FIG. 2, in accordance with an embodiment of the invention.

FIG. 4 is a flowchart of a process for calculating a bid for an advertisement based on the advertisement's conversion value, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

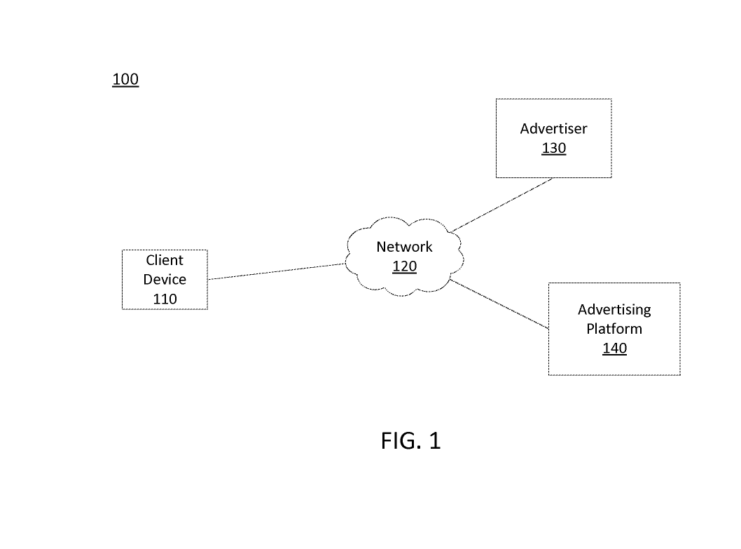

FIG. 1 is a high level block diagram of a system environment 100 for an advertising platform 140. The system environment 100 shown by FIG. 1 comprises one or more client devices 110 and a network 120, an advertiser 130, and the advertising platform 140. In alternative configurations, different and/or additional components may be included in the system environment 100. The embodiments described herein can be adapted to a generic online advertising platform or to an advertising platform that is part of a social networking system.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a tablet, or another suitable device. A client device 110 is configured to communicate via the network 120. In one embodiment, a client device 110 executes an application allowing a user of the client device 110 to interact with other client devices 110 and servers, such as the advertising platform 140 or a social networking system. For example, a client device 110 executes a browser application to enable interaction between the client device 110 and the advertising platform 140 via the network 120. In another embodiment, a client device 110 interacts with the advertising platform 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, LTE (Long Term Evolution), code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

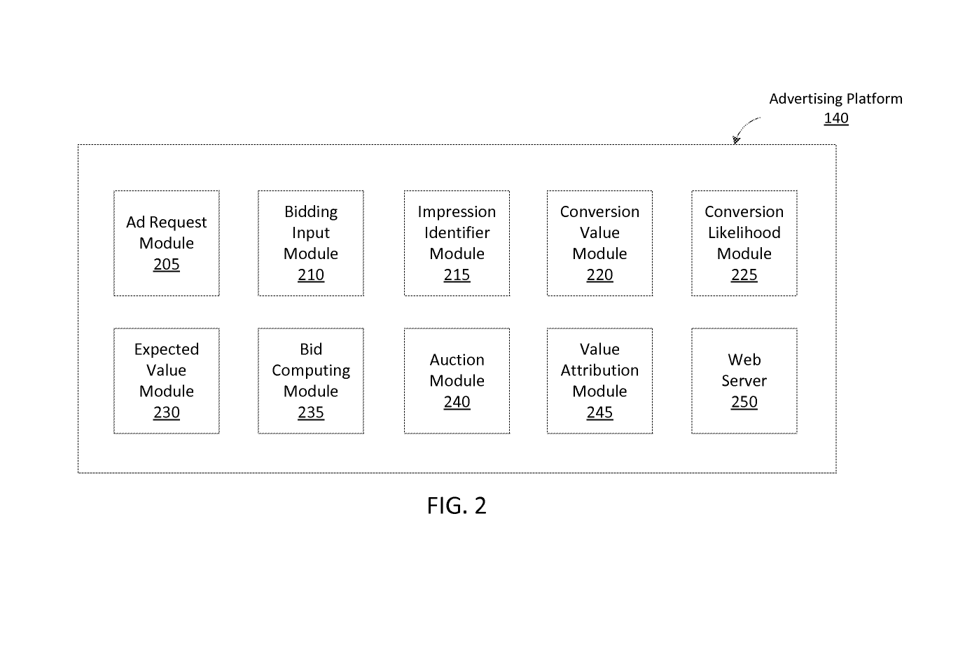

One or more advertisers 130 are coupled to the network 120. The advertiser 130, which may be embodied as a device of an advertising entity (e.g., a server hosted by an online advertising entity, a mobile device used by an advertiser, etc.), communicates with the advertising platform 140, which is further described below in conjunction with FIG. 2. In one embodiment, the advertiser 130 is an application provider communicating information describing applications for execution by a client device 110 or communicating data to client devices 110 for use by an application executing on the client device. An advertiser 130 may communicate information to the advertising platform 140, such as advertisements, content, or information for publication to one or more client devices 110.

FIG. 2 is an example block diagram of an architecture of the advertising platform 140. The advertising platform 140 shown in FIG. 2 includes an ad request module 205, a bidding input module 210, an impression identifier module 215, a conversion value module 220, a conversion likelihood module 225, an expected value module 230, a bid computing module 235, an auction module 240, a value attribution module 245, and a web server 250. In other embodiments, the advertising platform 140 may include additional, fewer, or different components for various applications. Conventional components such as network interfaces, security functions, load balancers, failover servers, management and network operations consoles, and the like are not shown so as to not obscure the details of the system architecture.

The ad request module 205 receives an advertisement request from an advertiser 130. The advertisement request includes advertisement content. The advertisement content can be text, image, audio, video, or any other suitable data presented to a user. In various embodiments, the advertisement content also includes a landing page specifying a network address to which a viewing user is directed when the advertisement is accessed.

Additionally, the advertisement request may include one or more targeting criteria specified by the advertiser. Targeting criteria included in an advertisement request specify one or more characteristics of viewing users eligible to be presented with content in the advertisement request. For example, targeting criteria are a filter to apply to fields of a user profile and/or actions associated with a viewing user to identify users having user profile information or actions satisfying at least one of the targeting criteria. The user profile and/or actions may be tracked by the advertising platform 140 or by a social networking system connected through the network 120 to the advertising platform 140. Hence, the targeting criteria allow an advertiser to identify groups of users matching specific targeting criteria, simplifying subsequent distribution of content to groups of users.

In embodiments in which the advertising platform 140 is part of a social networking system, the targeting criteria may specify actions or types of connections between a user and another user or object of the social networking system. The targeting criteria may also specify interactions between a user and objects performed external to the social networking system, such as objects on a server associated with an advertiser 130. For example, the targeting criteria identifies users that have taken a particular action, such as sending a message to another user, using an application, joining a group, leaving a group, joining an event, generating an event description, purchasing or reviewing a product or service using an online marketplace, requesting information from an advertiser 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

The bidding input module 210 determines a minimum ROI for the advertisement request. The minimum ROI is an amount that the advertiser 130 is willing to pay per unit value of a conversion of the advertisement associated with the advertisement request. The minimum ROI can be a ratio, a percentage, a dollar value, or any other indication of an amount relative to the value of the conversion of the advertisement. For example, the minimum ROI can be a ratio that specifies what an advertiser 130 is willing to pay 10¢ per dollar value of a conversion or that the advertiser 130 will pay 10% of the value of the conversion. In other examples, the minimum ROI is an amount that specifies what the advertiser 130 is willing to pay per the total value of the conversion. For example, the minimum ROI can specify that the advertiser 130 will pay $1 for a conversion worth $10.

The bidding input module 210 determines the minimum ROI based on a bidding input received from the advertiser 130. The bidding input indicates an amount that the advertiser 130 is willing to spend on the bid. In some embodiments, the bidding input is the advertiser's budget (i.e., the advertiser 130 is willing to spend $10 per conversion) for the advertisement request. The bidding input module 210 determines the minimum ROI by scaling the advertiser's budget by the value of the conversion. In some embodiments, the bidding input is a minimum ROI provided by the advertiser 130 or a minimum ROI from a previous advertisement request associated with the same advertisement. The bidding input can depend on the impression opportunity. For example, the bidding input for an impression opportunity that meets all of the advertisement request's targeting criteria may be valued more than an impression opportunity that meets a lower number of targeting criteria. In some embodiments, the bidding input module 210 determines the minimum ROI using a formula, algorithm, or equation provided by the advertiser 130. For example, the advertiser 130 might provide a bid using a standard bidding model in which the bid is optimized for the number of conversions and not the value of the conversions, and the bidding input module 210 can determine the minimum ROI based on this bidding input. In this example, the bidding input module 210 might determine the minimum ROI using information such as past history of bidding for this advertiser, past indications by the advertiser of the value of various types of conversions, based on general information provided by the advertiser about conversion values for different impression opportunities or information obtained by observing conversions for this advertiser over time, among other data and any combination of these data.

The impression identifier module 215 identifies an impression opportunity to deliver advertising to a viewing user of an online system, such as a social networking system or any other online system that might interact with or include the advertising platform 140. For example, the module 215 can identify an impression opportunity for the advertisement associated with the advertisement request. The impression opportunity is an instance during which the advertising platform 140 can display an advertisement to a viewing user. For example, the impression opportunity can occur when a user accesses a web page with space to display an advertisement. The impression identifier module 215 selects advertisements for the impression opportunity based on the targeting criteria and/or advertisement content associated with various advertisement requests, including the advertisement request received by advertiser 130. In some embodiments, the impression identifier module 215 selects an advertisement for the impression opportunity if the viewing user matches a threshold number of targeting criteria.

The conversion value module 220 estimates a value of the conversion, herein referred to as the “estimated conversion value.” The estimated conversion value is a prediction of the monetary worth of a single conversion for the advertisement. In one embodiment, this is the estimated conversion value for a conversion involving a particular viewing user or for a conversion involving a particular impression opportunity (since there can be more than one impression opportunity with a given viewing user). The value of a conversion of an advertisement may differ for different viewing users or across different impression opportunities. For example, a conversion of an ad for a social game application involving a viewing user that is a frequent player of social games might be more valuable than a conversion of the ad involving a viewing user that rarely uses social games, even though the advertiser may make the same amount of money from each user's purchase of the game as a result of the ad. Since the game user plays games frequently, this user is much more likely to share this game with others, possibly resulting in multiple additional purchases of the game and more overall value to the advertiser. Similarly, out of two impression opportunities for the game user, conversions associated with certain impression opportunities may be more valuable than others. For example, a conversion that occurs for an impression opportunity on a social networking website versus a news website might be more likely to result in the game user more immediately playing the social game and immediately sharing with others that might buy the game.

The estimated conversion value typically is the value of the advertised good or service, but it can also be the revenue generated per conversion, the profit per conversion, the monetary impact of the conversion on the advertiser's competitor, or any other value associated with the conversion for the advertisement. The advertiser 130 can provide the estimated conversion value for the conversion value module 220. In some embodiments, the advertiser 130 includes the estimated conversion value for the advertisement in the advertisement request. For example, an advertiser 130 may specify in the advertisement request that the conversion value is $5 for a $5 sandwich. The estimated conversion value can be based on other advertisement-specific information. In other embodiments, the advertising platform 140 determines the estimated conversion value automatically or without input from the advertiser.

In some embodiments, the conversion value module 220 calculates the estimated conversion value based on information about the viewing user, since as explained above, the estimated conversion value may be different for different viewing users. The conversion value module 220 can use a statistical formula, a machine learning algorithm, or any other formula to calculate the estimated conversion value, and the formula or algorithm used can be provided by the advertiser or set by the conversion value module 220. Where the formula or algorithm is set by the conversion value module 220, the module 220 may receive the inputs to the formula from the advertiser or may determine the inputs itself.

The formulas used by the conversion value module 220 can be a function of user-specific information known by the advertising platform 140. For example, in embodiments in which the advertising platform 140 interfaces with a social networking system, the conversion value module 220 receives profile information that describes viewing user characteristics, social connections, and online interactions associated with the viewing user. The conversion value module 220 calculates the estimated conversion value based on the received profile information. In some embodiments, the estimated conversion value can be based on the time of day the advertisement is displayed, the advertisement content, the viewing user's geographic location, or certain characteristics of or information about the viewing user. The conversion value module 220 can use information about the advertised product or service known by the advertiser 130 to calculate the estimated conversion value. For example, the conversion value module 220 can use the price of the advertised good or service or other financial information not provided in the advertisement request to calculate the determined conversion value. Other examples of the conversion value module 220 use a machine learning algorithm, based on information specific to the viewing user, to determine the estimated conversion value.

The conversion likelihood module 225 calculates a likelihood or probability of the conversion, herein referred to as the “conversion likelihood,” of the advertisement by the viewing user. The conversion likelihood module 225 calculates the conversion likelihood based on user-specific information known by the advertising platform 140. In one embodiment, the conversion likelihood module 225 receives profile information associated with the viewing user. The profile information can be from the viewing user's profile on a social networking system and may include characteristics of the viewing user, social networking connections of the viewing user, and interactions the viewing user has performed in the social networking system. The conversion likelihood module 225 calculates the conversion likelihood based on user-specific information known about the viewing user, such as the viewing user's profile information. For example, viewing user's with certain characteristics (e.g., users of certain age ranges, certain demographics, in certain locations, having certain likes and dislikes, among other characteristics) might be known to be more likely to click on an ad and buy a product based on the click than other users. Another factor that might be considered in by the conversion likelihood module 225 is historical information about a given user's clicks on ads, since users who click frequently on ads might be more likely to click again. Similarly, a user might be more likely to click on ads of a certain type (e.g., ads with images versus those without, ads on a particular topic, ads that include social context about friends or social networking connections who may have liked the product, ad shown at particular times of day or days of the week, etc.). The conversion likelihood is calculated separately for each viewing user or impression opportunity and can be specific to each viewing user or impression opportunity.

The expected value module 230 calculates the expected value of the conversion of the advertisement, herein referred to as the “expected conversion value.” The expected conversion value is the estimated conversion value adjusted for the likelihood of the conversion. The expected conversion value is based on both the estimated conversion value and the conversion likelihood. In some embodiments, the expected conversion value is the product of the conversion likelihood and the estimated conversion value. For example, the equation to determine the expected value of the conversion can be:

V_{expected}=P(conversion)×V_{estimated}

In the above equation, V_{estimated} is the estimated value of the conversion, P(conversion) is the conversion likelihood, and V_{expected} is the expected value of the conversion. However, the expected value module 230 can use other equations, formulas, or algorithms based on the estimated value of the conversion to calculate the expected value of the conversion.

The bid computing module 235 computes a bid amount for the advertisement request. The bid amount is provided for the impression opportunity. The bid amount is based on both the expected conversion value and on the minimum ROI. In some embodiments, the bid amount is computed by scaling the expected conversion value by the minimum ROI, such as by multiplying the expected conversion value by the minimum ROI.

The auction module 240 receives the bid amount and associates the bid amount with the advertisement request. The advertisement request is submitted to an auction process. The advertising platform 140 uses the auction process to select an advertisement to display to the viewing user. The advertisement selection is based on the bid amount and may additionally be based on the tracking criteria associated with the advertisement. In embodiments in which the advertising platform is connected to a social network, the advertisement may be displayed on a social network interface, such as a newsfeed.

The value attribution module 245 attributes a portion of the expected value of the conversion to the advertisement selected by the auction module 240. The value attribution module 245 tracks subsequent actions by the viewing user after the advertising platform 140 provides the advertisement for display to the viewing user or after the user clicks on the advertisement. The value attribution module 245 receives an indication of a conversion by the viewing user (e.g., determines that the user purchased the advertised product). Based on the tracked actions, the value attribution module 245 attributes a portion of the expected conversion value to the advertisement. The portion of the expected conversion value can be a binary number (1=conversion attributed to the advertisement|0=conversion not attributed to the advertisement), a percentage (e.g., 30% of the expected conversion value is attributed to the advertisement), or a dollar value (e.g., $20 is attributed to the advertisement). Conversion attribution information may be sent to the conversion value module 220 to improve the formula or algorithm that calculates the estimated conversion value and thus the expected conversion value. For example, this information can be used in a machine learning process to improve the ability of the conversion value module 220 to determine the estimated conversion value for each viewing user or impression opportunity.

The web server 250 links the advertising platform 140 via the network 120 to the one or more client devices 110, as well as to the one or more advertisers 130. The web server 250 serves web pages, as well as other web-related content, such as JAVA®, FLASH®, XML and so forth. The web server 250 may receive and route messages among the advertisers 130, the advertising platform 140, and the client device 110, for example, ad content, messages, or other information. Additionally, the web server 250 may provide application programming interface (API) functionality to send data directly to native client device operating systems, such as IOS®, ANDROID™, WEBOS® or RIM®.

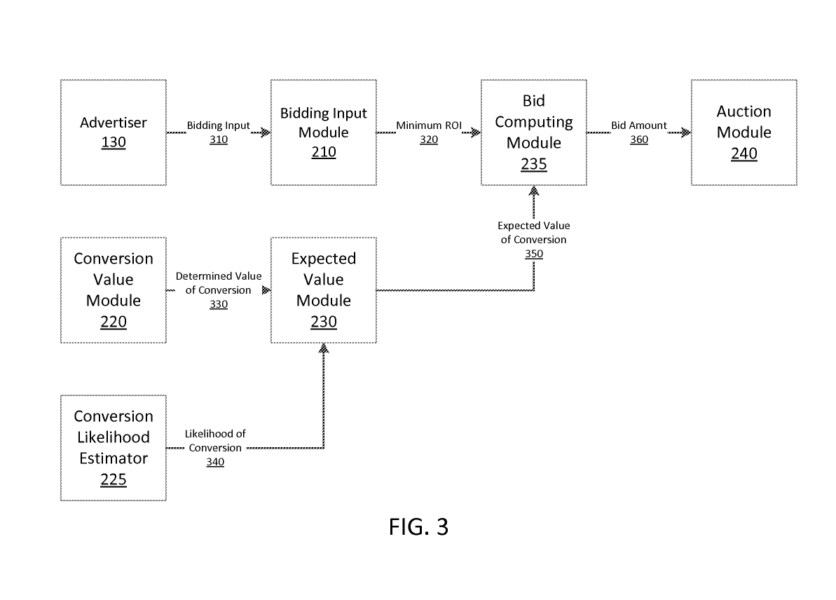

FIG. 3 is a flow diagram of the bid computing process within the system of FIG. 2, in accordance with an embodiment of the invention. FIG. 3 illustrates various signals, such as the bidding input 310, minimum ROI 320, determined conversion value 330, conversion likelihood 340, expected conversion value 350, and bid amount 360 being transferred between modules. The signals can be embodied as analog signals, digital signals sent over a logic signal, or objects stored in computer memory.

As described above, the bid amount 360 is calculated by the bid computing module 235. The bid amount 360 is based on both the minimum ROI 320 and the expected conversion value 350. The expected conversion value 350, in turn, is based on the estimated conversion value 350 from the conversion value module 220 and the conversion likelihood 340 from the conversion likelihood estimator 225. The minimum ROI 320 is determined based on the bidding input 310 received from the advertiser 130.

### Method for Calculating Bids for Advertisements Based on Conversion Value

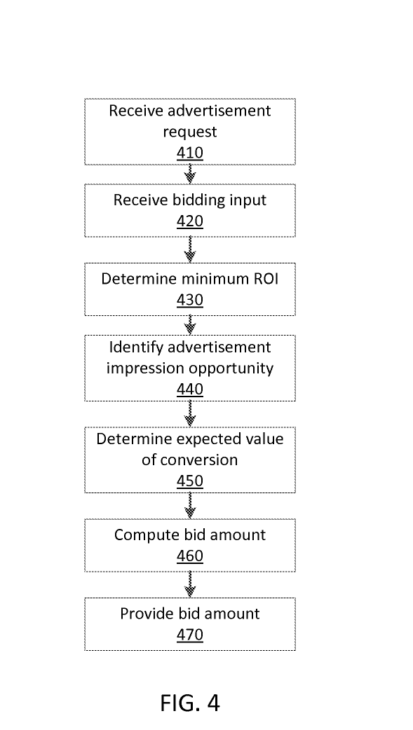

FIG. 4 is a flowchart of a process for calculating a bid for an advertisement based on the advertisement's conversion value, in accordance with an embodiment of the invention. Unless otherwise noted, the process of FIG. 4 is performed by the advertising platform 140, which may store instructions that cause a processor on the advertising platform 140 to execute the process described in FIG. 4. The process of FIG. 4 may include additional or alternative steps.

The advertising platform 140 receives 410 an advertisement request from the advertiser 130. The advertisement request includes advertisement content, which includes but is not limited to text, image, audio, video, or any other data suitable for presentation to a viewing user. The advertisement request can also include targeting criteria, which specifies one or more characteristics of viewing users eligible to be presented with content in the advertisement request. The targeting criteria specify actions, profile information, or connections of a viewing user associated with eligible viewing users.

The advertising platform 140 receives 420 a bidding input from the advertiser 130. The bidding input indicates how much the advertiser 130 is willing to pay to display the advertisement. The bidding input can be a maximum or minimum value for a bid for the advertisement request, a budget for the advertisement, or a minimum ROI for the advertisement. The bidding input can be received from the advertiser 130, e.g., as part of the advertisement request. In some embodiments, in which the advertising platform is connected to a social networking system, the advertising platform 140 determines the bidding input based on tracked interactions of the viewing user in the social networking system and profile information of the viewing user.

The advertising platform 140 determines 430 a minimum ROI based on the bidding input. The minimum ROI is an amount that the advertiser is willing to pay per unit of value of a conversion of the advertisement. The minimum ROI can be expressed as a ratio, a percentage, a dollar amount, or any other suitable expression of value. For example, the minimum ROI can indicate the advertiser 130 is willing to pay 25¢ per dollar value of the conversion for the advertisement. The minimum ROI can be submitted as part of the advertisement request by the advertiser 130 or can be determined 430 by the advertising platform 140 using a formula, algorithm, or other equation provided by the advertiser 130. The equation may be a function of the targeting criteria for the advertisement and user-specific information about the viewing user.

The advertising platform 140 identifies 440 an impression opportunity to advertise to a viewing user. For example, a viewing user may have just refreshed a page or navigated to a new page, and hence there is an opportunity to provide advertising to the viewing user. The advertising platform 140 might also identify 440 that the impression opportunity is one that is appropriate for the advertisement of the advertiser that was received 410, since it may match the targeting criteria of that advertisement request. The impression opportunity is an instance during which the advertising platform 140 can provide an advertisement for display to a viewing user. The advertising platform 140 can identify 440 that the impression opportunity is one that matches the advertisement request by using an affinity score representing the affinity of the viewing user for the advertisement or advertisement request. The affinity score is a measure of the viewing user's affinity for the advertisement associated with the advertisement request and may be based on profile information belonging to the viewing user, such as profile information from a social network. Further description of affinity scores is provided in U.S. Pat. No. 8,402,094, which is hereby referenced in its entirety. Furthermore, the advertising platform 140 can identify 440 that the impression opportunity is a match for the advertisement request based on other factors related to the impression opportunity, such as the time of day of the impression, the web page the impression is displayed on, and the placement of the advertisement.

The advertising platform 140 determines 450 an expected value of a conversion for the advertisement. The expected value of the conversion can be the value of an advertised product or service, the revenue generated by the conversion, the profit generated by the conversion, the impact of the conversion on a competitor of the advertiser 130, or any other value. The expected value of the conversion can be provided by the advertiser 130 or determined by the advertising platform 140 using a statistical formula, a machine learning algorithm, or any other relevant function or equation. The advertising platform 140 can use user-specific information known by the advertising platform 140 to calculate the expected value of the conversion. For example, if the advertising platform 140 is connected to a social networking system, the advertising platform 140 can use profile information, social connections, or tracked interactions to calculate the expected value of the conversion. Furthermore, the advertising platform 140 can use information about the advertised product or service to determine 450 the expected value of the conversion. For example, the advertising platform 140 can determine the expected value of the conversion based on the price of the advertised good or service. The advertising platform 140 can also take into account the likelihood of the conversion when determining 450 the expected conversion value.

The advertising platform 140 computes 460 a bid amount. The bid amount is the amount bid by the advertiser 130 to display the advertisement during the impression opportunity. The bid amount is based on both the expected value of the conversion as well as the minimum ROI. In some embodiments, the bid amount is the product of the expected value of the conversion and the minimum ROI.

The advertising platform 140 provides 470 the bid amount to an advertisement selection process. The advertisement selection process can be an advertising auction performed by the advertising platform 140 or performed by another system. The bid amount is provided with the advertisement request to the advertising auction. Based on the bid amounts of the provided advertisement requests, the advertising platform 140 selects an advertisement to provide for display to the viewing user.

The advertising platform 140 may track actions by the viewing user after providing the viewing user with the selected advertisement. While tracking the actions of the viewing user, the advertising platform can receive an indication that the advertisement conversion occurred. The indication of the conversion can be any tracked action by the viewing user, such as following a link, making a purchase, viewing an advertisement, visiting a landing page, or any other relevant action. Based on the tracked actions by the viewing user, the advertising platform 140 attributes a portion of the expected conversion value to the advertisement. The advertising platform 140 can use any statistical formula, machine learning algorithm, or other apparent function to calculate the attributed portion of the expected value of the conversion.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving from an advertiser an advertisement request to present an advertisement to a plurality of users of an online system;
receiving a bidding input from the advertiser for the advertisement request;
determining, based on the bidding input, a minimum return on investment (ROI) that specifies an amount that the advertiser is willing to pay per unit of value of a conversion of the advertisement;
identifying an impression opportunity to deliver advertising to a viewing user of the plurality of users of the online system;
determining an expected value of a conversion of the advertisement for the impression opportunity;
computing, by a processor, a bid amount for the advertisement request based on the determined expected value of a conversion of the advertisement scaled by the minimum ROI; and
providing the computed bid amount for the advertisement to an advertisement selection process.

2. The method of claim 1, wherein the determined expected value is based on (1) a likelihood of a conversion of the advertisement by the viewing user and (2) an estimated value of a conversion of the advertisement by the viewing user.

3. The method of claim 2, further comprising determining, by a processor, the estimated value of the conversion of the advertisement by the viewing user, the estimated value being a function of each particular impression opportunity for that advertisement.

4. The method of claim 2, wherein the function used in determining the estimated value of a conversion is provided by the advertiser.

5. The method of claim 2, wherein the computed bid amount is a product of the minimum ROI, the likelihood of a conversion of the advertisement by the viewing user, and the estimated value of a conversion of the advertisement by the viewing user.

6. The method of claim 2, further comprising:
receiving profile information associated with the user; and
based on the received profile information, determining the likelihood of the conversion of the advertisement by the viewing user.

7. The method of claim 3, wherein the received profile information is a social network user profile belonging to the user.

8. The method of claim 1, wherein the bidding input is a bid provided by the advertiser, and wherein the minimum ROI is determined based on the bid.

9. The method of claim 1, wherein the bidding input is the minimum ROI, and wherein determining the minimum ROI comprises using the minimum ROI input by the advertiser.

10. The method of claim 1, further comprising:
selecting an advertisement for the user based on the computed bid amount; and
providing the selected advertisement for display to the user.

11. The method of claim 10, further comprising:
tracking one or more interactions between the user and the received advertisement;
receiving an indication that a conversion associated with the received advertisement occurred; and
attributing a portion of the estimated value of the conversion to the advertisement.

12. A computer program product comprising a non-transitory computer-readable storage medium containing computer program code for:
receiving from an advertiser an advertisement request to present an advertisement to a plurality of users of an online system;
receiving a bidding input from the advertiser for the advertisement request;
determining, based on the bidding input, a minimum return on investment (ROI) that specifies an amount that the advertiser is willing to pay per unit of value of a conversion of the advertisement;
identifying an impression opportunity to deliver advertising to a viewing user of the plurality of users of the online system;
determining an expected value of a conversion of the advertisement for the impression opportunity;
computing a bid amount for the advertisement request based on the determined expected value of a conversion of the advertisement scaled by the minimum ROI; and
providing the computed bid amount for the advertisement to an advertisement selection process.

13. The computer program product of claim 12, wherein the determined expected value is based on (1) a likelihood of a conversion of the advertisement by the viewing user and (2) an estimated value of a conversion of the advertisement by the viewing user.

14. The computer program product of claim 13, further comprising instructions that, when executed, cause the processor to determine the estimated value of the conversion of the advertisement by the viewing user, the estimated value being a function of each particular impression opportunity for that advertisement.

15. The computer program product of claim 13, wherein the function used in determining the estimated value of a conversion is provided by the advertiser.

16. The computer program product of claim 13, wherein the computed bid amount is a product of the minimum ROI, the likelihood of a conversion of the advertisement by the viewing user, and the estimated value of a conversion of the advertisement by the viewing user.

17. The computer program product of claim 13, further comprising program code for:
receiving profile information associated with the user; and
based on the received profile information, determining the likelihood of the conversion of the advertisement by the viewing user.

18. The computer program product of claim 14, wherein the received profile information is a social network user profile belonging to the user.

19. The computer program product of claim 12, wherein the bidding input is a bid provided by the advertiser, and wherein the minimum ROI is determined based on the bid.

20. The computer program product of claim 12, wherein the bidding input is the minimum ROI, and wherein determining the minimum ROI comprises using the minimum ROI input by the advertiser.

21. The computer program product of claim 12, further comprising computer program code for:
selecting an advertisement for the user based on the computed bid amount; and
providing the selected advertisement for display to the user.

22. The computer program product of claim 21, further comprising computer program code for:
tracking one or more interactions between the user and the received advertisement;
receiving an indication that a conversion associated with the received advertisement occurred; and
attributing a portion of the estimated value of the conversion to the advertisement.

23. A system comprising:
a computer program processor;
a non-transitory computer-readable storage medium, the storage medium including instructions that cause the processor to:
receive from an advertiser an advertisement request to present an advertisement to a plurality of users of an online system;
receive a bidding input from the advertiser for the advertisement request;
determine, based on the bidding input, a minimum return on investment (ROI) that specifies an amount that the advertiser is willing to pay per unit of value of a conversion of the advertisement;
identify an impression opportunity to deliver advertising to a viewing user of the plurality of users of the online system;
determine an expected value of a conversion of the advertisement for the impression opportunity;
compute, by a processor, a bid amount for the advertisement request based on the determined expected value of a conversion of the advertisement scaled by the minimum ROI; and
provide the computed bid amount for the advertisement to an advertisement selection process.

24. The system of claim 23, further comprising instructions that cause the processor to:
select an advertisement for the user based on the computed bid amount; and
provide the selected advertisement for display to the user.

25. The system of claim 24, further comprising instructions that cause the processor to:
track one or more interactions between the user and the received advertisement;
receive an indication that a conversion associated with the received advertisement occurred; and
attribute a portion of the estimated value of the conversion to the advertisement.
